(19) United States
(12) Patent Application Publication
(10) Pub. No.: US 2016/0201369 A1
(43) Pub. Date: Jul. 14, 2016

(54) ADJUSTABLE HINGE

(71) Applicant: Amesbury Group, Inc, Amesbury, MA (US)

(72) Inventor: Douglas John Criddle, Sioux Falls, SD (US)

(73) Assignee: Amesbury Group, Inc., Amesbury, MA (US)

(21) Appl. No.: 14/592,241

(22) Filed: Jan. 8, 2015

(51) Int. Cl. E05D 7/00; E05D 5/12; E05D 3/02

(52) U.S. Cl. CPC E05D 7/0045; E05D 3/022; E05D 5/128

(57) ABSTRACT

A hinge has a first section with a first leaf and a first barrel secured to the first leaf. The first barrel has a substantially round inner cross-section. A second section has a second leaf and a second barrel secured to the second leaf. The second barrel has a substantially rectangular inner cross-section. A hinge pin has a first round portion and a substantially rectangular portion defining a threaded opening therethrough. The first round portion is disposed in the first barrel and the substantially rectangular portion is disposed in the second barrel. Adjustment of an adjustment screw disposed in the threaded opening adjusts a position of the substantially rectangular portion within the second barrel.

A hinged door or window may have a small gap between the door/window and the frame. For many reasons including aesthetics, air infiltration, and security, these gaps need to be minimized.

### SUMMARY

The hinge described herein allows adjustment of the gaps between the hinged door/window and the frame without removing the hinge or the door/window. Upper and lower knuckles of the hinge may be connected to a door frame, while a central knuckle may be connected to a door panel. A hinge pin joins the three knuckles. Upper and lower portions of the hinge pin may be round and disposed within a round barrel of each of the upper and lower knuckles. A central portion of the hinge pin is rectangular and is disposed within a rectangular barrel of the central knuckle. In one direction, the rectangular barrel has dimensions significantly larger than the one of outer dimensions of the central portion of the hinge pin. An adjustment screw is threaded through the central portion of the pin. As the adjustment screw is rotated, the position of the hinge pin within the rectangular barrel is adjusted, moving the pin linearly relative to the barrel. Thus, the upper and lower knuckles move relative to the central knuckle. Slide pins on either side of the adjustment screw ensure proper transition of the pin without binding.

In one aspect, the technology relates to a hinge having: a first section having: a first leaf; and a first barrel secured to the first leaf, the first barrel having a substantially round inner cross-section; a second section having: a second leaf; and a second barrel secured to the second leaf, the second barrel having a substantially rectangular inner cross-section; a hinge pin having a first round portion and a substantially rectangular portion defining a threaded opening therethrough, and wherein the first round portion is disposed in the first barrel and the substantially rectangular portion is disposed in the second barrel; and an adjustment screw disposed in the threaded opening, wherein a rotation of the adjustment screw adjusts a position of the substantially rectangular portion within the second barrel. In an embodiment, the first barrel includes a first barrel axis and wherein the adjustment screw defines an adjustment axis substantially orthogonal to the first barrel axis. In another embodiment, the rectangular portion is positionable in the second barrel in a first extreme position, a second extreme position, and an intermediate position disposed between the first extreme position and the second extreme position, and wherein each of the first extreme position, the second extreme position, and the intermediate position are disposed along the adjustment axis. In yet another embodiment, when in the intermediate position, the first barrel axis is aligned with a second barrel axis defined by the second barrel. In still another embodiment, a slide is included, wherein the rectangular portion further defines a slide opening disposed parallel to the threaded opening, and wherein the slide is disposed within the slide opening.

In another embodiment of the above aspect, the second barrel defines an adjustment opening configured to receive a tool to adjust the adjustment screw. In an embodiment, a third section disposed proximate the second section and opposite the first section, the third section having: a third leaf; and a third barrel secured to the third leaf, the third barrel having a substantially round inner cross-section; wherein the hinge pin further includes a second round portion disposed within the third barrel. In another embodiment, a third barrel axis defined by the third barrel is aligned with a first barrel axis defined by the first barrel.

In another aspect, the technology relates to a hinge having: a first knuckle having a substantially rectangular barrel including a cross-section having a width and a length, wherein the rectangular barrel defines an access opening; a hinge pin has a rectangular portion, wherein a width of the rectangular portion is sized to be received by the width of the rectangular barrel, and wherein the rectangular portion defines a threaded opening; and an adjustment screw disposed in the threaded opening so as to be accessed from the access opening, wherein a rotation of the adjustment screw translates the hinge pin along the length of the rectangular barrel. In an embodiment, the rectangular barrel includes an adjustment axis disposed along the length, wherein the hinge pin is positionable in the rectangular barrel in a first extreme position, a second extreme position, and an intermediate position, and wherein each of the first extreme position, the second extreme position, and the intermediate position is disposed along the adjustment axis. In another embodiment, at least one slide is included, wherein the rectangular portion of the hinge pin further defines at least one slide opening disposed parallel to the threaded opening, and wherein the at least one slide is disposed within the at least one slide opening. In yet another embodiment, a second knuckle having a barrel having a circular cross-section, and wherein the hinge pin further includes a first round portion extending axially from a first end of the rectangular portion, wherein the first round portion is received within the circular barrel of the second knuckle. In still another embodiment, a third knuckle includes a barrel having a circular cross-section, and wherein the hinge pin further includes a second round portion extending axially from a second end of the rectangular portion, wherein the second round portion is received within the circular barrel of the third knuckle.

In another embodiment of the above aspect, the length of the substantially rectangular barrel defines an adjustment axis, and wherein the circular barrel of the second knuckle, the circular barrel of the third knuckle, and the hinge pin are axially aligned along a hinge axis orthogonal to the adjustment axis, and wherein the hinge axis is linearly positionable along the adjustment axis. In an embodiment, the substantially rectangular barrel of the first knuckle has a substantially square cross-section.

In another aspect, the technology relates to a hinge having: an upper outer knuckle having an upper round inner barrel; a lower outer knuckle having a lower round inner barrel; a middle knuckle having a rectangular inner barrel; a hinge pin having an upper round portion disposed in the upper round inner barrel, a lower round portion disposed in the lower round inner barrel, and a middle rectangular portion disposed in the rectangular inner barrel, wherein the middle rectangular portion is linearly translatable within the rectangular inner barrel. In an embodiment, a single adjustment mechanism for linearly translating the middle rectangular portion within the rectangular inner barrel. In another embodiment, the middle rectangular portion further defines a slide opening disposed parallel to the single adjustment mechanism, and wherein the slide is disposed within the slide opening. In yet another embodiment, the rectangular inner barrel includes a substantially square cross-section. In still another embodiment, the middle rectangular portion includes a first dimension and a second dimension different than the first dimension.

### BRIEF DESCRIPTION OF THE DRAWINGS

There are shown in the drawings, embodiments which are presently preferred, it being understood, however, that the technology is not limited to the precise arrangements and instrumentalities shown.

FIG. 1 is a perspective view of an adjustable hinge.

FIG. 2 is an exploded perspective view of the adjustable hinge of FIG. 1.

FIG. 3 is a side view of the adjustable hinge of FIG. 1.

FIGS. 4A and 4B are cross-sectional views of the adjustable hinge of FIG. 3.

FIG. 5 is partial perspective view of an adjustable hinge secured to a door and a frame.

FIGS. 6A and 6B are schematic views of spatial relationships between components of an adjustable hinge.

### DETAILED DESCRIPTION

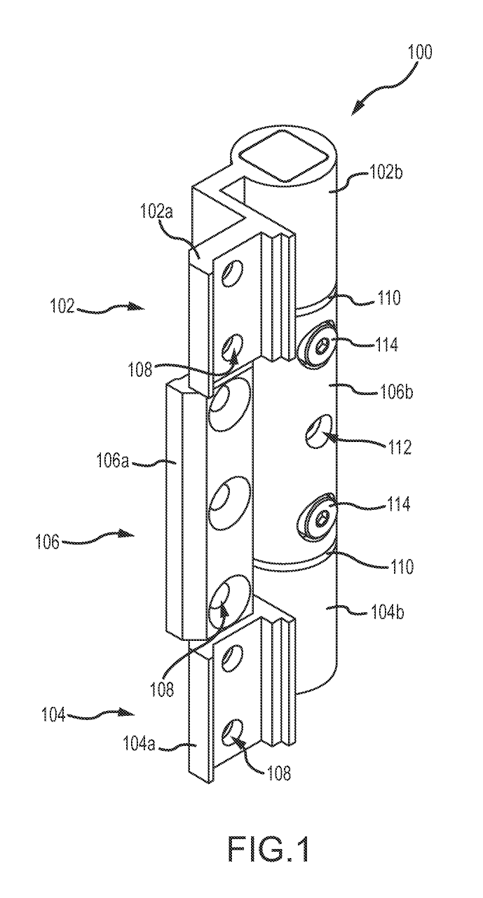

FIG. 1 is a perspective view of an adjustable hinge 100, which can be used to adjust a position of a door panel or window sash relative to a door or window frame. Although the hinges described herein can be used in either pivoting windows or doors, the remainder of this disclosure will describe a pivoting door, for clarity. The hinge 100 includes an upper outer section or knuckle 102, a lower outer section or knuckle 104, and a middle or central section or knuckle 106. Each section or knuckle 102-106 includes a leaf 102a, 104a, 106a and a barrel 102b, 104b, 106b secured thereto. Each leaf 102a, 104a, 106a defines one or more openings 108 that receive screws, bolts, or other fasteners to secure the leaf 102a, 104a, 106a to a door panel or a door frame. In certain embodiments, upper and lower outer leaves 102a, 104a are secured to the door frame, while the middle leaf 106a is secured to the door panel. Each of the upper and lower outer barrels 102b, 104b may be spaced from the middle barrel 106b with a low-friction bushing 110. The middle barrel 106b defines an access or adjustment opening 112 configured to allow tool access to enable adjustment of an adjustment mechanism, described below. Additionally, one or more slides 114 may be secured within the middle barrel 106b to reduce binding during adjustment of the adjustment mechanism, as described below.

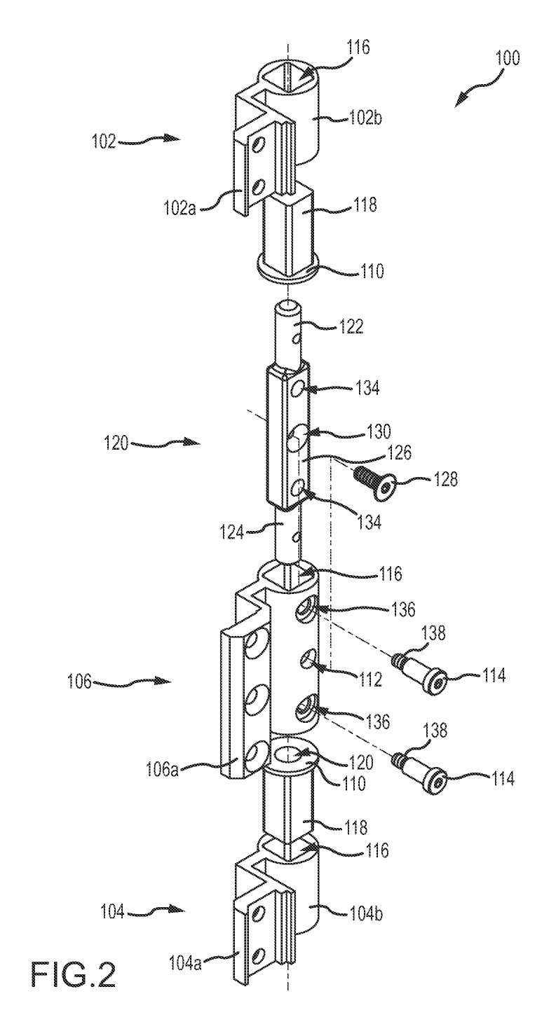

FIG. 2 is an exploded perspective view of the adjustable hinge 100 of FIG. 1. Certain components of the hinge 100 are described above with regard to FIG. 1 and are not necessarily described further. Inner tubes 116 of each of barrels 102b, 104b, and 106b define a substantially rectangular cross-section. In certain embodiments such as that depicted in FIG. 2, the cross-sections may be square. In the depicted embodiment, each bushing 110 has a mating portion 118 that fits within the inner tube 116. Each bushing 110 may define its own round barrel 120 thus, each of upper and lower outer barrels 102b, 104b includes a substantially round cross-sectional barrel to receive a mating portion of a hinge pin 120. In other embodiments, the inner tubes 116 of the upper and lower outer barrels 102b, 104b may themselves define a round barrel, with or without a bushing.

The hinge pin 120 includes multiple portions axially aligned along the length of the hinge pin 120. Upper and lower round portions 122, 124 are sized so as to be received in the upper and lower outer barrels 102b, 104b, respectively. More specifically, in the depicted embodiment, the upper and lower round portions 122, 124 are received in the round barrel 120 of a respective bushing 110. A middle substantially rectangular portion 126 of the hinge pin 120 is received within the rectangular inner tube 116 of the middle barrel 106b. In general, the dimensions of the rectangular inner tube 116 allow for a position of the hinge pin 120 within the middle barrel 106b to be adjusted. This adjustment changes the position of the outer knuckles 102, 104 relative to the middle knuckle 106, so as to change the position of the door panel within the door frame.

Positioning of the middle knuckle 106 relative to the outer knuckles 102, 104 may be performed utilizing an adjustment mechanism. In the depicted embodiment, the adjustment mechanism is a screw 128 that is received within a threaded opening 130 defined by the middle portion 126 of the hinge pin 120. The screw 128 may be accessed via the access opening 112 define the middle barrel 106b. Additionally, one or more slides 114 may pass through a corresponding number of slide openings 134 defined by the middle portion 126. These slides 114 help ensure smooth operation of the adjustment mechanism, without twisting or binding. Although various configurations are contemplated, the adjustment screw 128 may be inserted into the threaded opening 130 prior to insertion of the hinge pin 120 into the middle barrel 106b. Once inserted, the slides 114 may be inserted into corresponding slide openings 136 in the middle barrel 106b, though the slide openings 134, and secured via threads 138 within the middle barrel 106b.

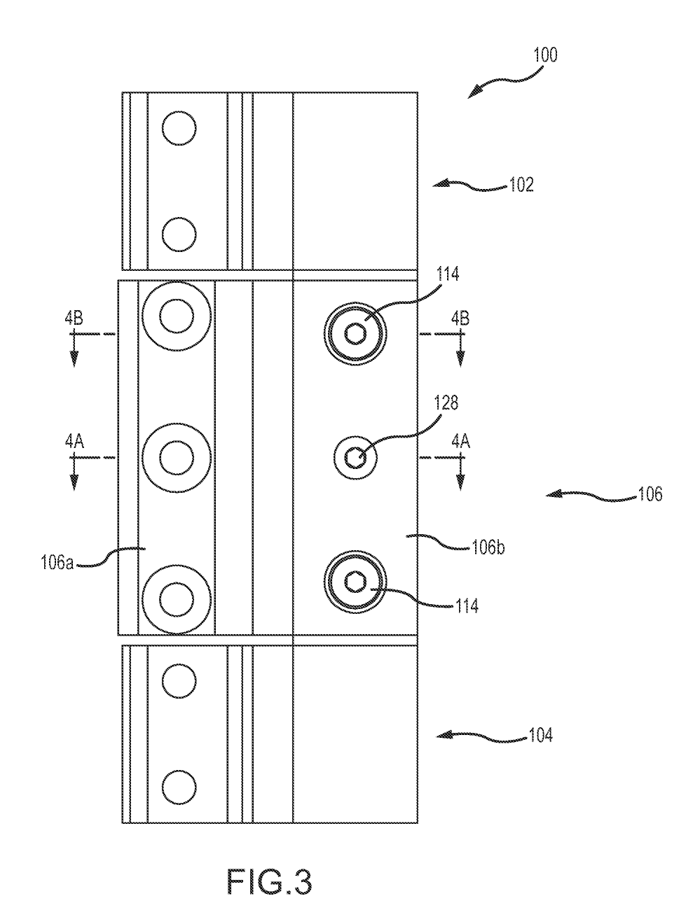

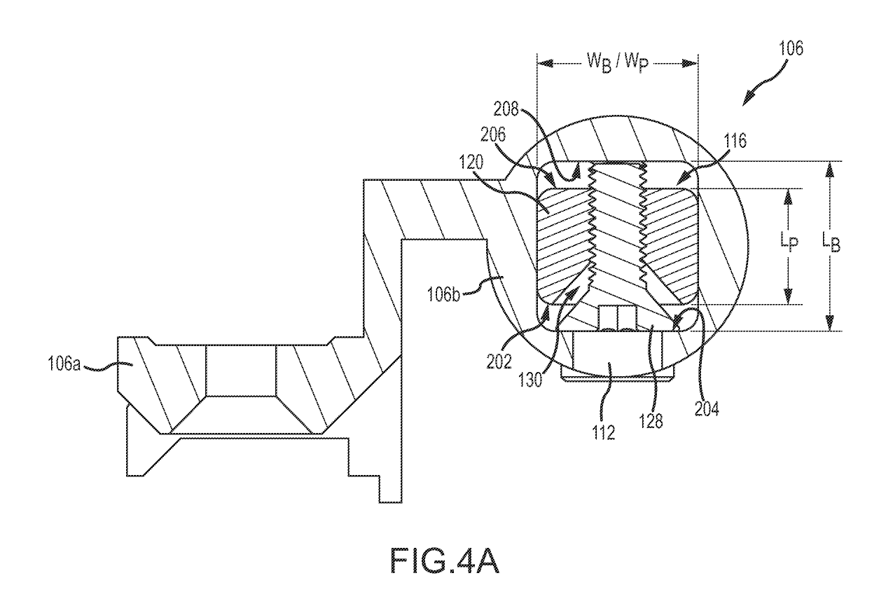

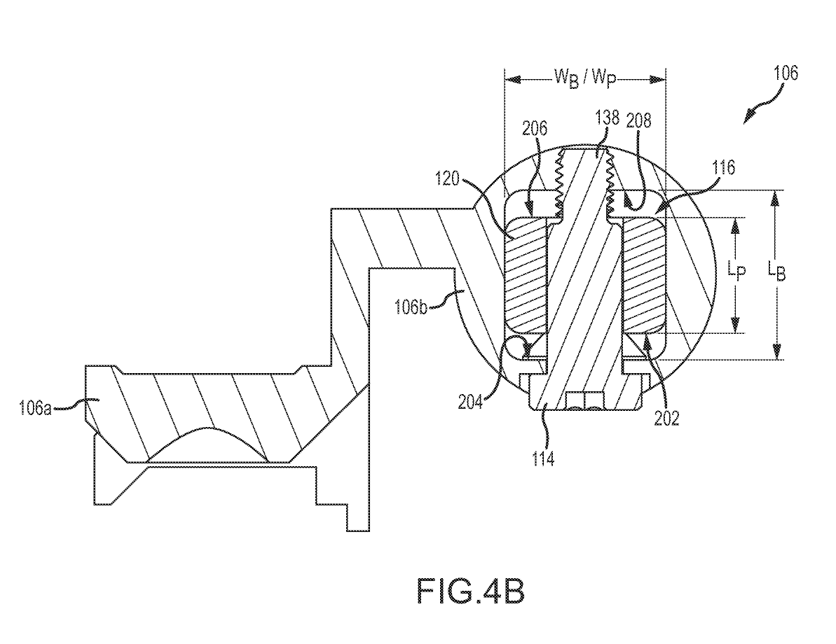

FIG. 3 is a side view of the adjustable hinge 100 of FIG. 1. Certain components of the hinge 100 are described above with regard to FIGS. 1 and/or 2 and are not necessarily described further. FIG. 3 depicts the parallel arrangement of the slides 114 and the adjustment screw 128, each of which extend into the middle barrel 106b, as described above. FIGS. 4A and 4B are cross-sectional views of the adjustable hinge 100 of FIG. 3. More specifically, FIG. 4A is a cross-section through the adjustment screw 128, while FIG. 4B is a cross-section through the slide 114. Both of FIGS. 4A and 4B are described simultaneously. The middle barrel 106b may have a rectangular inner cross-sectional tube 116. In the depicted embodiment, the inner tube 116 is in the form of a square, such that a length L_{B} and a width W_{B} are substantially equal. The middle portion 126 of the hinge pin 120 has a width W_{P} sized so as to fit within the width W_{B} of the inner tube 116. This fit may be close enough to allow for translatable or slidable movement of the hinge pin 120 within the inner tube 116, without twisting or binding. Thus, pin width W_{P} is substantially similar to barrel width W_{B}. Additionally, the hinge pin 120 includes a length L_{P} that, in the depicted embodiment, is different than both the length L_{B} of the inner portion 116 and the width W_{P} of the hinge pin 120.

By rotating the adjustment screw 128, the hinge pin 120 translates along an adjustment axis A_{S} defined by the length L_{B} of the inner tube 116 and the adjustment screw 128. One or more slides 114 help enable sliding, translating movement of the hinge pin 120 without binding or twisting. When in a first extreme position, a first side 202 of the hinge pin 120 contacts a front surface 204 of the inner tube 116. When in a second extreme position, a second side 206 of the hinge pin 120 within the inner tube 116 contacts a rear surface 208 of the inner tube 116. In the extreme positions, contact between the sides 202, 206 of the hinge pin 120 and the surfaces 204, 208 of the inner tube 116 prevents further movement of the hinge pin 120 in the relevant direction. In an intermediate position, as depicted in FIGS. 4A and 4B, the hinge pin 120 is disposed between the first extreme position and the second extreme position. Due to at least the linear configuration of the adjustment screw 128 and slides 114, each of the first extreme position, the second extreme position, and any intermediate positions disposed therebetween are all disposed along the axis A_{S}.

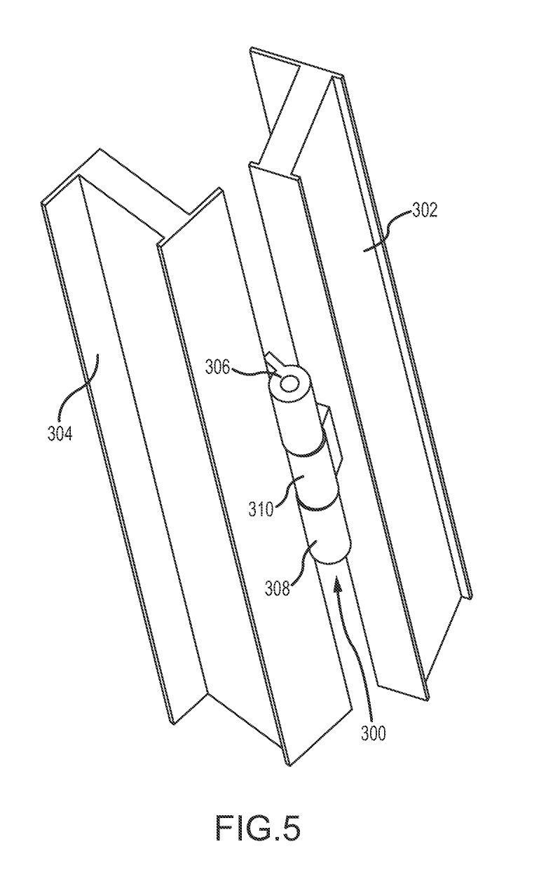

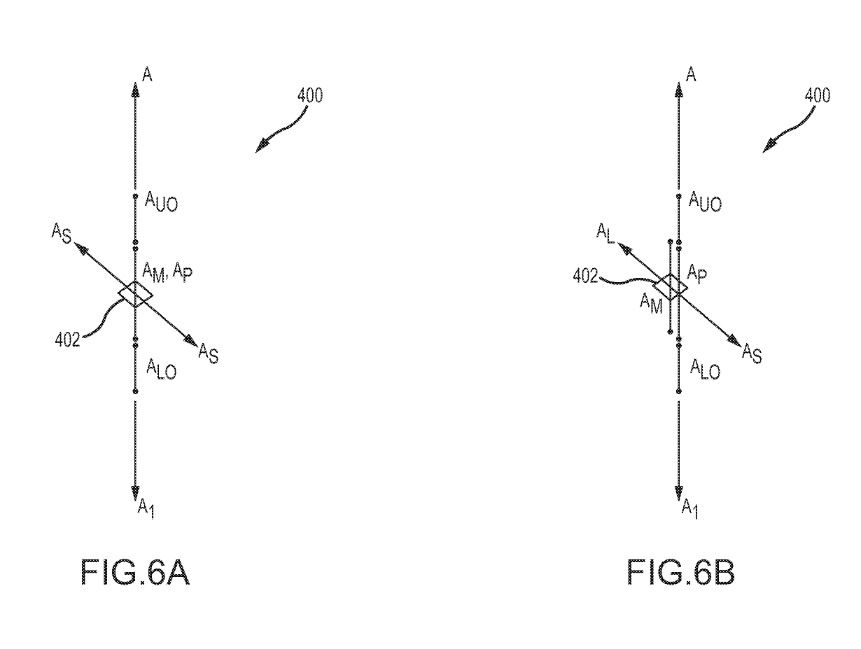

FIG. 5 is partial perspective view of an adjustable hinge 300 secured to a door 302 and a frame 304. The hinge 300 includes upper and lower outer knuckles 306, 308, respectively, as well as a middle knuckle 310. The middle knuckle 310 is depicted slightly out of alignment with the upper and lower outer knuckles 306, 308 so as to adjust gaps present between the door 302 and the frame 304. This adjustability is described in more detail below in FIGS. 6A and 6B, which are schematic views of spatial relationships between components of an adjustable hinge 400, in accordance with one embodiment of the technology. The axes of the various components are depicted generally by line segments and are described further below. Axis A_{UO} corresponds to an upper outer barrel of the hinge, while an axis A_{LO} corresponds to the lower outer barrel of the hinge. An axis A_{M} corresponds to the middle barrel. In FIG. 6A, axis A_{M} is depicted aligned with an axis A_{P} of the hinge pin, when the hinge pin is disposed at an intermediate position centrally located within the middle barrel 402 (depicted in FIGS. 6A and 6B by the rectangular shape). In FIG. 6A, each of axes A_{UO}, A_{LO}, A_{M}, and A_{P} are aligned along a hinge axis A about which pivoting occurs. The hinge pin axis A_{P} can be translated along an adjustment axis A_{S} (defined at least in part by an adjustment screw or mechanism), to adjust the gaps that may be present between a door and door frame. The adjustment axis A_{S} is substantially orthogonal to each of axes A_{UO}, A_{LO}, A_{M}, and A_{P} and substantially parallel to the adjustment mechanism and slides (if present).

FIG. 6B depicts such an adjusted configuration. There, the position of the pin axis A_{P} has been translated to one extreme position within the middle barrel 402. As can be seen, axes A_{UO}, A_{LO}, and A_{P} are moved relative to axis A_{M}. Thus, the position of the door relative to the door frame is also moved, so as to adjust gaps present therebetween. Of course, the pin axis A_{P} can also be translated elsewhere along the axis A_{S}, thus effecting a change in alignment between axis A_{M} and remaining axes A_{UO}, A_{LO}, and A_{P}, which maintain alignment regardless of the position of axis A_{P} relative to axis A_{M}.

The materials utilized in the manufacture of the adjustable hinges described herein may be those typically utilized for hinge manufacture, e.g., zinc, steel, brass, stainless steel, etc. Material selection for most of the components may be based on the proposed use of the adjustable hinge. Appropriate materials may be selected for hinges used on particularly heavy door panels, as well as on hinges subject to certain environmental conditions (e.g., moisture, corrosive atmospheres, etc.). For particularly light-weight door panels (for example, cabinet door panels), molded plastic, such as PVC, polyethylene, etc., may be utilized for the various components. Nylon, acetal, Teflon®, or combinations thereof may be utilized for the bushings to reduce friction, although other low-friction materials are contemplated.

The terms first, second, third, upper, lower, outer, middle, top, bottom, panel, frame, etc., as used herein, are relative terms used for convenience of the reader and to differentiate various elements of the adjustable hinge from each other. In general, unless otherwise noted, the terms are not meant to define or otherwise restrict location of any particular element. For example, the outer knuckles may be secured to the panel and the middle knuckle may be secured to the frame, or vice-versa. Alternatively, the adjustable hinge may be used with the barrels oriented horizontally. In another embodiment, an adjustable hinge may only utilize an upper and lower knuckle, along with a hinge pin having a single rectangular section and a single round section.

While there have been described herein what are to be considered exemplary and preferred embodiments of the present technology, other modifications of the technology will become apparent to those skilled in the art from the teachings herein. The particular methods of manufacture and geometries disclosed herein are exemplary in nature and are not to be considered limiting. It is therefore desired to be secured in the appended claims all such modifications as fall within the spirit and scope of the technology. Accordingly, what is desired to be secured by Letters Patent is the technology as defined and differentiated in the following claims, and all equivalents.

What is claimed is:

1. A hinge comprising:
a first section comprising:
a first leaf; and
a first barrel secured to the first leaf, the first barrel comprising a substantially round inner cross-section;
a second section comprising:
a second leaf; and
a second barrel secured to the second leaf, the second barrel comprising a substantially rectangular inner cross-section;
a hinge pin comprising a first round portion and a substantially rectangular portion defining a threaded opening therethrough, and wherein the first round portion is disposed in the first barrel and the substantially rectangular portion is disposed in the second barrel; and
an adjustment screw disposed in the threaded opening, wherein a rotation of the adjustment screw adjusts a position of the substantially rectangular portion within the second barrel.

2. The hinge of claim 1, wherein the first barrel comprises a first barrel axis and wherein the adjustment screw defines an adjustment axis substantially orthogonal to the first barrel axis.

3. The hinge of claim 2, wherein the rectangular portion is positionable in the second barrel in a first extreme position, a second extreme position, and an intermediate position disposed between the first extreme position and the second extreme position, and wherein each of the first extreme position, the second extreme position, and the intermediate position are disposed along the adjustment axis.

4. The hinge of claim 3, wherein when in the intermediate position, the first barrel axis is aligned with a second barrel axis defined by the second barrel.

5. The hinge of claim 1, further comprising:
a slide, wherein the rectangular portion further defines a slide opening disposed parallel to the threaded opening, and wherein the slide is disposed within the slide opening.

6. The hinge of claim 1, wherein the second barrel defines an adjustment opening configured to receive a tool to adjust the adjustment screw.

7. The hinge of claim 1, further comprising:
a third section disposed proximate the second section and opposite the first section, the third section comprising:
a third leaf; and
a third barrel secured to the third leaf, the third barrel comprising a substantially round inner cross-section;
wherein the hinge pin further comprises a second round portion disposed within the third barrel.

8. The hinge of claim 7, wherein a third barrel axis defined by the third barrel is aligned with a first barrel axis defined by the first barrel.

9. A hinge comprising:
a first knuckle comprising a substantially rectangular barrel comprising a cross-section having a width and a length, wherein the rectangular barrel defines an access opening;
a hinge pin comprising a rectangular portion, wherein a width of the rectangular portion is sized to be received by the width of the rectangular barrel, and wherein the rectangular portion defines a threaded opening; and
an adjustment screw disposed in the threaded opening so as to be accessed from the access opening, wherein a rotation of the adjustment screw translates the hinge pin along the length of the rectangular barrel.

10. The hinge of claim 9, wherein the rectangular barrel comprises an adjustment axis disposed along the length, wherein the hinge pin is positionable in the rectangular barrel in a first extreme position, a second extreme position, and an intermediate position, and wherein each of the first extreme position, the second extreme position, and the intermediate position is disposed along the adjustment axis.

11. The hinge of claim 9, further comprising at least one slide, wherein the rectangular portion of the hinge pin further defines at least one slide opening disposed parallel to the threaded opening, and wherein the at least one slide is disposed within the at least one slide opening.

12. The hinge of claim 9, further comprising a second knuckle comprising a barrel having a circular cross-section, and wherein the hinge pin further comprises a first round portion extending axially from a first end of the rectangular portion, wherein the first round portion is received within the circular barrel of the second knuckle.

13. The hinge of claim 12, further comprising a third knuckle comprising a barrel having a circular cross-section, and wherein the hinge pin further comprises a second round portion extending axially from a second end of the rectangular portion, wherein the second round portion is received within the circular barrel of the third knuckle.

14. The hinge of claim 13, wherein the length of the substantially rectangular barrel defines an adjustment axis, and wherein the circular barrel of the second knuckle, the circular barrel of the third knuckle, and the hinge pin are axially aligned along a hinge axis orthogonal to the adjustment axis, and wherein the hinge axis is linearly positionable along the adjustment axis.

15. The hinge of claim 12, wherein the substantially rectangular barrel of the first knuckle has a substantially square cross-section.

16. A hinge comprising:
an upper outer knuckle comprising an upper round inner barrel;
a lower outer knuckle comprising a lower round inner barrel;
a middle knuckle comprising a rectangular inner barrel;
a hinge pin comprising an upper round portion disposed in the upper round inner barrel, a lower round portion disposed in the lower round inner barrel, and a middle rectangular portion disposed in the rectangular inner barrel, wherein the middle rectangular portion is linearly translatable within the rectangular inner barrel.

17. The hinge of claim 16, further comprising a single adjustment mechanism for linearly translating the middle rectangular portion within the rectangular inner barrel.

18. The hinge of claim 17, further comprising a slide, wherein the middle rectangular portion further defines a slide opening disposed parallel to the single adjustment mechanism, and wherein the slide is disposed within the slide opening.

19. The hinge of claim 16, wherein the rectangular inner barrel comprises a substantially square cross-section.

20. The hinge of claim 19, wherein the middle rectangular portion comprises a first dimension and a second dimension different than the first dimension.
